(19) United States
(12) Patent Application Publication
(10) Pub. No.: US 2015/0248426 A1
(43) Pub. Date: Sep. 3, 2015

(54) METHOD AND SYSTEM FOR RETRIEVING USER-SPECIFIC INFORMATION

(71) Applicant: YAHOO! INC., Sunnyvale, CA (US)

(72) Inventors: Dong Che, Beijing (CN); Gaonan Zhang, Beijing (CN); Li Rong, Beijing (CN)

(21) Appl. No.: 14/346,512

(22) PCT Filed: Mar. 15, 2013
(86) PCT No.: PCT/CN2013/000304

§ 371 Date: Mar. 21, 2014

(51) Int. Cl. G06F 17/30

(52) U.S. Cl. CPC G06F 17/30091; G06F 17/30867

(57) ABSTRACT

Method, system, and programs for retrieving user-specific information. In one example, an environment factor associated with a user is obtained. An identification of the user is also determined. A request for retrieving user-specific information is then sent to a remote database. The request is generated based on the environment factor and the identification of the user. In response to the request, the user-specific information sent from the remote database is received.

### BACKGROUND

1. Technical Field

The present teaching relates to methods, systems, and programming for retrieving user-specific information.

2. Discussion of Technical Background

Environment factors (surround information), such as location, time, weather, etc., have been used by services on mobile devices. For example, location-based services (LBS) are information and entertainment services accessible with mobile devices through the mobile network and utilizing the ability to make use of the geographical position of the mobile device. LBS may utilize multiple technologies such as the global positioning system (GPS) satellite network, cellular networks, Wi-Fi networks, radio-frequency identification (RFID) and other technologies. Popular service categories of LBS include mapping and navigation, search and information, social networking and entertainment, recreation and fitness as well as tracking.

Various mobile device location platforms have been offered to developers and third parties to respond user behaviors by analyzing location and/or other real-time detected environment factors in their applications. Most known platforms enable LBS to the general audience or at best to a group of users (user cohort) without knowing the history, preference, and demographic of each specific user. In other words, known solutions lack the functionalities of identifying the specific user to whom the services are provided and retrieving the corresponding user-specific information, which is essential for providing personalized content and services to each user. Therefore, there is a need to provide an improved solution for retrieving user-specific information on a user device to solve the above-mentioned problems.

### SUMMARY

The present teaching relates to methods, systems, and programming for retrieving user-specific information.

In one example, a method, implemented on at least one machine each of which has at least one processor, storage, and a communication platform connected to a network for retrieving user-specific information, is disclosed. An environment factor associated with a user is obtained. An identification of the user is also determined. A request for retrieving user-specific information is then sent to a remote database. The request is generated based on the environment factor and the identification of the user. In response to the request, the user-specific information sent from the remote database is received.

In a different example, a system for retrieving user-specific information, comprising a user-specific information retrieving module implemented on a mobile device, is disclosed. The user-specific information retrieving module comprises an environment factor unit, a user identification unit, and an information retrieving unit. The environment factor unit is configured to obtain an environment factor associated with the mobile device of a user. The user identification unit is configured to determine an identification of the user. The information retrieving unit is configured to send a request for retrieving user-specific information to a remote database. The request is generated based on the environment factor and the identification of the user. The information retrieving unit is further configured to receive the user-specific information sent from the remote database in response to the request.

Other concepts relate to software for retrieving user-specific information. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for retrieving user-specific information, wherein the information, when read by the machine, causes the machine to perform a series of steps. An environment factor associated with a user is obtained. An identification of the user is also determined. A request for retrieving user-specific information is then sent to a remote database. The request is generated based on the environment factor and the identification of the user. In response to the request, the user-specific information sent from the remote database is received.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a exemplary functional block diagram of a system for retrieving user-specific information, according to an embodiment of the present teaching;

FIG. 2 is an exemplary functional block diagram of an application residing on a user device, according to an embodiment of the present teaching;

FIG. 3 is an exemplary functional block diagram of a user-specific information retrieving module residing on a user device, according to an embodiment of the present teaching;

FIG. 4 depicts exemplary environment factors for retrieving user-specific information, according to an embodiment of the present teaching;

FIG. 5 is a flowchart of an exemplary process for retrieving user-specific information, according to an embodiment of the present teaching;

FIG. 6 is an exemplary time line chart for retrieving user-specific information, according to an embodiment of the present teaching;

FIG. 7 is an exemplary functional block diagram of a user-specific information retrieving engine residing on a server, according to an embodiment of the present teaching;

FIG. 8 is a flowchart of another exemplary process for retrieving user-specific information, according to an embodiment of the present teaching;

FIG. 9 is a high level depiction of an exemplary system in which user-specific information retrieval is applied, according to an application embodiment of the present teaching;

FIG. 10 is an exemplary functional block diagram of a user device on which the application and the user-specific information retrieving module shown in FIGS. 2 and 3, respectively, reside, according to an embodiment of the present teaching; and

FIG. 11 is an exemplary functional block diagram of a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of retrieving user-specific information based on real-time detected environment factors (surround information) on a user device. The method and system as disclosed herein aim at improving the end-users' experience on receiving personalized content and services on their mobile devices and providing an end-to-end solution to third-party application developers. For end-users, the method and system allow mobile applications to retrieve user-specific information for their specific functionalities based on real-time detected environment factors, thereby better meeting the user intent. As to the developers of the mobile applications, the method and system as disclosed herein provide an interface between the mobile applications and a centralized user information database, which significantly reduces the implementation time of an integrated user-specific information retrieving function.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

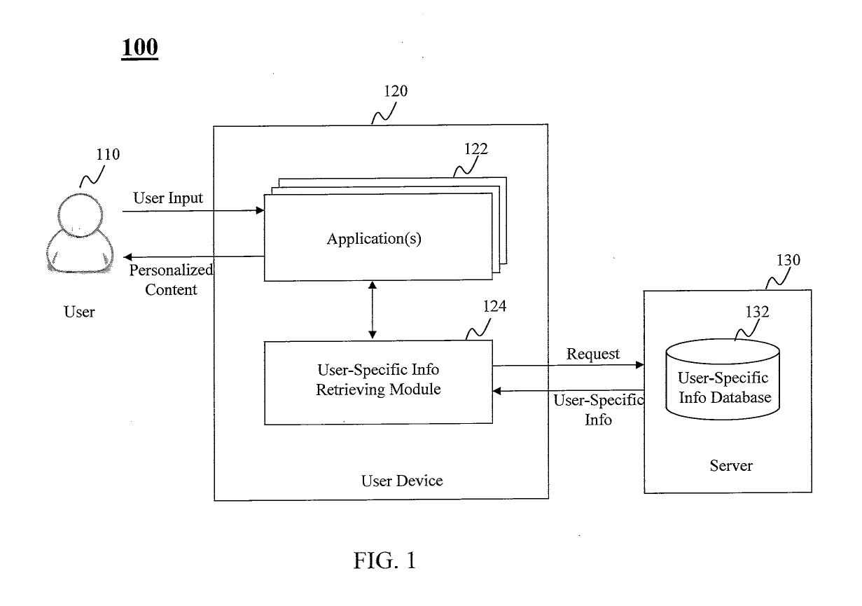

FIG. 1 is an exemplary functional block diagram of a system 100 for retrieving user-specific information, according to an embodiment of the present teaching. The system 100, in this example, includes a user 110, a user device 120, and a server 130. The user device 120 may be a laptop computer, desktop computer, netbook computer, media center, mobile device, gaming console, set-top box, printer, or any other suitable device. In this example, the user device 120 includes a mobile device (handheld device or portable device), such as but not limited to, a smart phone, a tablet, a music player, a handheld gaming console, and a GPS.

One or more applications 122 and a user-specific information retrieving module 124 may reside on the user device 120. The user 110 may communicate with the applications 122 implemented on the user device 120 by sending user input and obtaining content and/or services from the user device 120. The applications 122 may be any suitable applications pre-installed on the user device 120, such as a web browser, etc., or any third-part applications installed by the user 110 such as a social network client application, a travel agent application, etc. For example, the user 110 may input a destination address to a navigation application on the user device 120 and obtain, from the navigation, content associated with a route and an estimated arrival time to the destination address from the user 110′s current location. The user 110′s current location in the above example may be obtained from, for example, the GPS on the user device 120 as one of the environment factors (surround information) that triggers the service of the navigation application in real-time.

The content obtained from the applications 122 may be further personalized with respect to the user 110 based on user-specific information associated with the user 110. The user-specific information may include the user 110′s preference, history, and/or demographics. For example, referring to the above example related to a navigation application, the user-specific information may include whether the user 110 prefers a route including a toll road or not, how often the user 110 has driven on a route including highways, or the age of the user 110. Then the navigation application may generate a personalized route for the user 110 based on the user-specific information associated with the user 110. Thus, the user 110 can receive personalized content from the applications 122, in accordance with this embodiment.

The user-specific information may be obtained at the applications 122 from the user-specific information retrieving module 124. The user-specific information retrieving module 124 may be, for example, a software library in the form of compiled binary that can be integrated in the applications 122 by third-party developers of the applications 122 on various mobile operating systems, e.g., iOS, Android, Windows Phone, etc. The library may include application programming interfaces (APIs) allowing developers of the applications 122 to retrieve user-specific information for personalization from a centralized user database, as descried in detail below. In this example, the user-specific information is retrieved by the user-specific information retrieving module 124 from the server 130. For example, after a request associated with the user 110 is sent by the user-specific information retrieving module 124 to the server 130, the server 130 may return user-specific information associated with the user 110 to the user-specific information retrieving module 124, as a response to the request. In one situation, the server 130 may be a remote server located far from the user 110.

The server 130 may include a user-specific information database 132. The user-specific information database 132 may store user-specific information associated with a plurality of users including the user 110. For example, referring to the above example related to a navigation application, user-specific information associated with the user 110 may be retrieved from the user-specific information database 132, such as the frequency of the user 110 driving on highways in the past one month or the age of the user 110, upon a request with respect to the navigation application. In another example, for a restaurant application, user-specific information, including frequency and/or recency of visiting a Chinese restaurant in the last three weeks, declared interests of Chinese cuisine (e.g., dim sum), or nationally (Chinese), may be retrieved by the user-specific information retrieving module 124 from the user-specific information database 132.

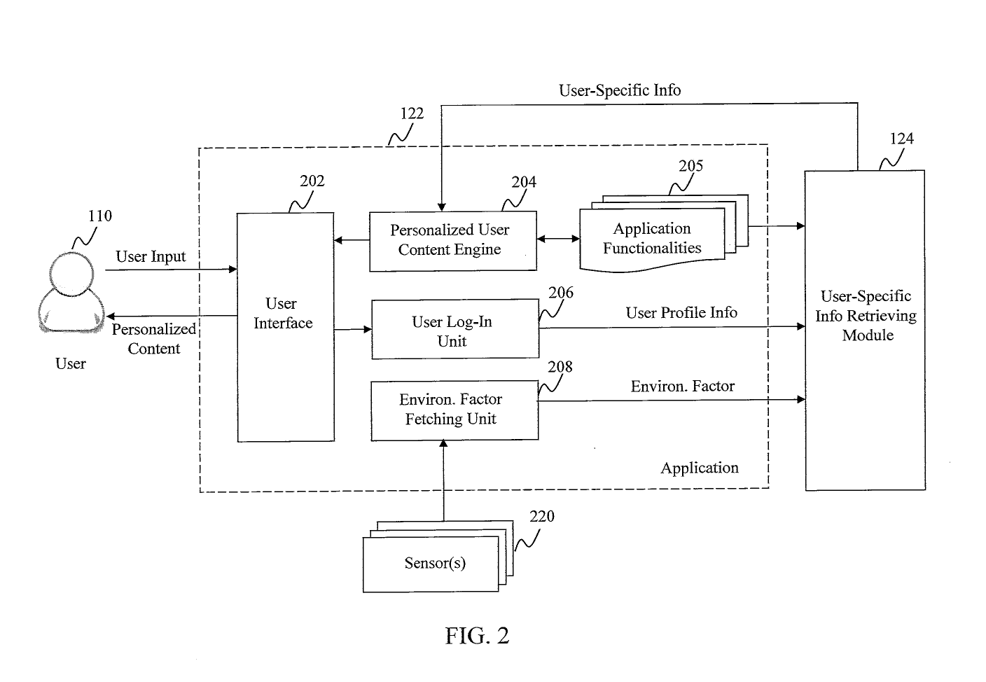

FIG. 2 is an exemplary functional block diagram of an application 122 residing on a user device, according to an embodiment of the present teaching. In this example, the application 122 may include a user interface 202, a personalized user content engine 204, a user log-in unit 206, and an environment factor fetching unit 208. User input and personalized content may be communicated between the user 110 and the application 122 via the user interface 202. The user log-in unit 202 may be configured for fetching and sending some user profile information to the user-specific information retrieving module 124. The user profile information may include the user 110's log-in information, which is associated with a user identification (ID) of the user 110. In this example, the user 110 may be promoted to enter its user ID in order to use the application 122. In another example, when the user 110 logs in an email account at the user device, user profile information associated with a user ID of the user 110 may be obtained by the user log-in unit 206. The user profile information may be sent to the user-specific information retrieving module 124 for retrieving user-specific information that can be utilized by the application 122.

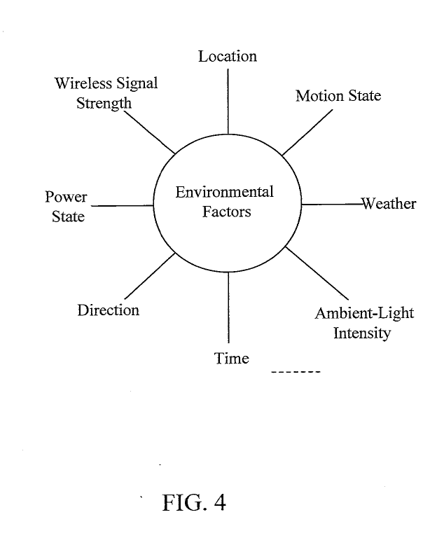

The environment factor fetching unit 208 may obtain one or more environment factors (surround information) associated with the user 110 from one or more sensors 220 or the operating system on the user device. The environment factor associated with the user 110 may represent an environment the user 110 is involved in at that moment. FIG. 4 depicts some exemplary environment factors for retrieving user-specific information, according to an embodiment of the present teaching. As shown in FIG. 4, the environment factors may include, e.g., a location of the user 110, a time or a weather status related to that location, the current ambient-light intensity, a motion state of the user 110, e.g., stillness, low speed movement, high speed movement, etc., a wireless signal strength (network condition), or a power state related to the user device of the user 110, etc. The sensors 220 generating the environment factors may be either located at or connected to the user device. For example, a motion sensor on a car of the user 110 may generate an environment factor representing a speed and a moving direction of the car at that moment. The environment factors may be retrieved continuously monitored in real time and serve as triggers for retrieving user-specific information. For example, if a restaurant application detects presence of the user 110 in a restaurant, the current location may be sent to the user-specific information retrieving module 124 to trigger the request of retrieving information related to the user's dinning preference or dinning history at the restaurant from a centralized user database.

In one example, both the environment factor and the user profile information may be sent to the user-specific information retrieving module 124 for retrieving user-specific information. In another example, one of application functionalities may also be sent to the user-specific information retrieving module 124 for retrieving user-specific information. The application functionalities 205 stored at the application 122 may represent a specific function of an application. For example, a navigation application may have a specific function of navigation, i.e., providing a suggested driving route between a location of the user 110 and a predetermined destination, at every moment of the user 110's driving. In another example, a restaurant application may have functions such as dinning recommendation or reservation.

The user-specific information retrieving module 124 then retrieves user-specific information for the application 122 based on environment factors, user profile information, and application functionalities. It can be understood that in some embodiments, user-specific information may be generated based on merely the user profile information. However, both the environment factor and the application functionality can be helpful for generating the user-specific information. For example, the environment factor may help the user-specific information retrieving module 124 to focus on retrieving user-specific information merely related to the real time detected environment factors, e.g., a movie theatre where the user 110 is located. The application functionality may further help to focus the user-specific information retrieving on information related to what the user 110 is trying to do, e.g., looking for a movie shown at the movie theatre, looking for a restaurant near the movie theatre, how to go home from the movie theatre, etc.

The generated user-specific information may be received at the personalized user content engine 204, from the user-specific information retrieving module 124. The personalized user content engine 204 may generate personalized content based on the user-specific information and one of the application functionalities 205 related to the user 110's input. The generated personalized content may then be presented to the user 110 by the personalized user content engine 204, via the user interface 202. For example, if the user 110 is located in a movie theatre and using a ticket purchasing functionality of a movie application, a list of recommend movies may be presented to the user based on retrieved user specific-information, such as the user's declared interest of watching a particular movie (e.g., user's status on social media website “I want to watch the latest 007 movie!”), user's frequency of watching a particular type of movie in the past six months (e.g., watching every Disney cartoon movie), or the age of the user with respect to film rating.

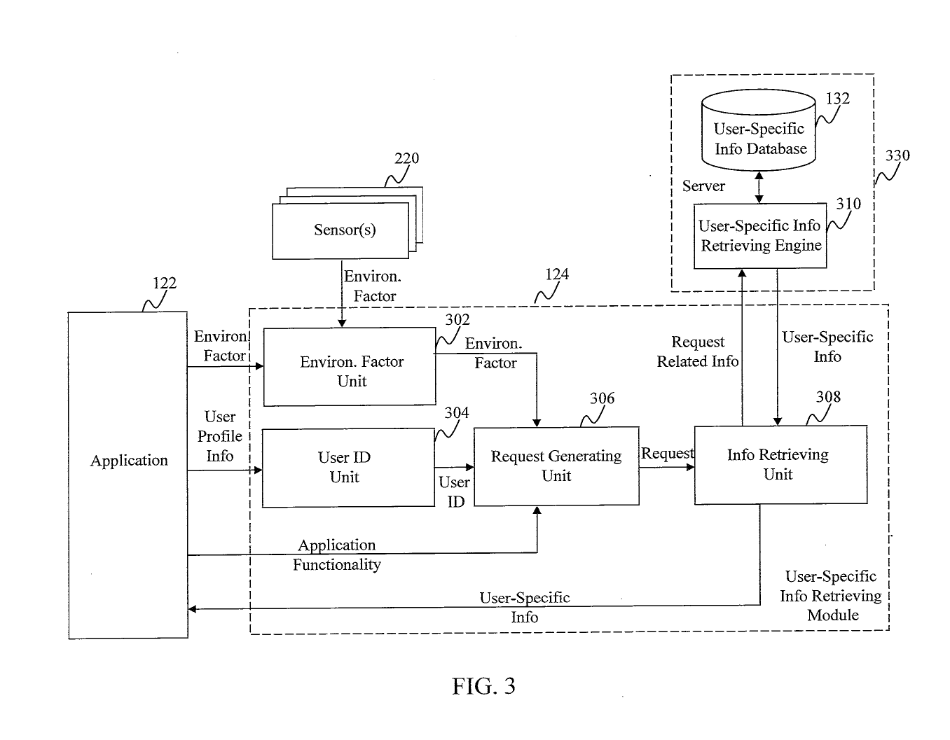

FIG. 3 is an exemplary functional block diagram of a user-specific information retrieving module 124 residing on a user device, according to an embodiment of the present teaching. The user-specific information retrieving module 124 in this example includes an environment factor unit 302, a user ID unit 304, a request generating unit 306, and an information retrieving unit 308. In one example, the environment factor unit 302 may receive one or more environment factors from the application 122. In another example, the environment factor unit 302 may receive environment factors from the sensors 220 or the operating system of the user device directly. The environment factor unit 302 may analyze the received environment factors and send some or all of the received environment factors to the request generating unit 306. The selection may be based on, for example, information recorded from previous user- specific information generations at the user-specific information retrieving module 124. The user ID unit 304 may receive user profile information associated with the user 110 from the application 122 and generate a user ID associated with the user 110 based on the user profile information, which is unique for the user 110. The user ID may be sent by the user ID unit 304 to the request generating unit 306.

The request generating unit 306 may generate a request based on an environment factor received from the environment factor unit 302, a user ID received from the user ID unit 304, and an application functionality received from the application 122. In this example, the request may include several parameters, including the user's ID, the environment factor, and the type of user-specific information associated with the request and/or a criterion related to the user-specific information to be retrieved. One type of the user-specific information includes, for example, user's preference, such as user's declared or inferred short-term and long-term interests. Another type of the user-specific information includes user's history, i.e., behavior patterns, such as frequency or recency of certain activities. Still another type of the user-specific information includes user's demographics, including age, sex, nationality, and residency, to name a few. In one example, the request may include the user ID as “John Doe,” the current location as “ABC fitness center,” and the type of user-specific information as “frequency of workout.” Additionally or optionally, a criterion may also be included as another parameter to further define the scope of the user-specific information. In the above-mentioned example, the request may further include the criterion as “in this year.”

The information retrieving unit 308 may generate and send request related information based on the request to a server 330 and retrieve user-specific information associated with the request from the server 330. The request may be considered as a search query with multiple conditions, including the user ID, environment factor, type of the user-specific information, and/or additional criterion. Records in the user-specific information database are searched against the conditions in the request to find a match. The matching record is then returned as a response to the request. The retrieved user-specific information may then be sent to the application 122 for generating personalized content based on the user-specific information.

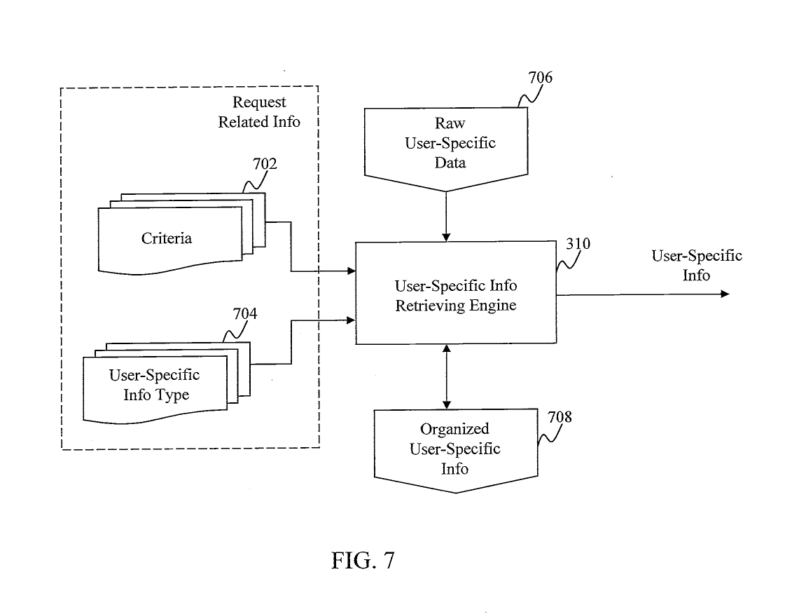

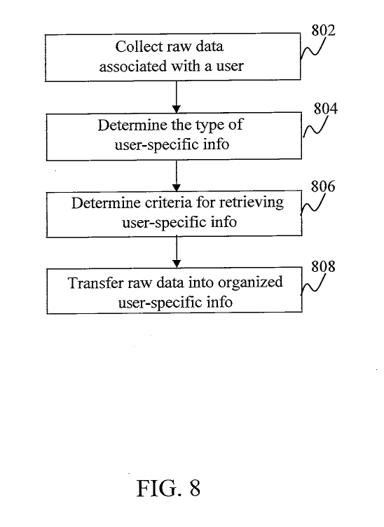

The server 330 in this example includes the user-specific information database 132 as described above and a user-specific information retrieving engine 310. The user-specific info retrieving engine 310 may receive and analyze the request related information and provide the user-specific information based on the request related information and data stored in the user-specific information database 132. More details related to a process of the user-specific information retrieving engine 310 will be described later in association with FIGS. 7 and 8.

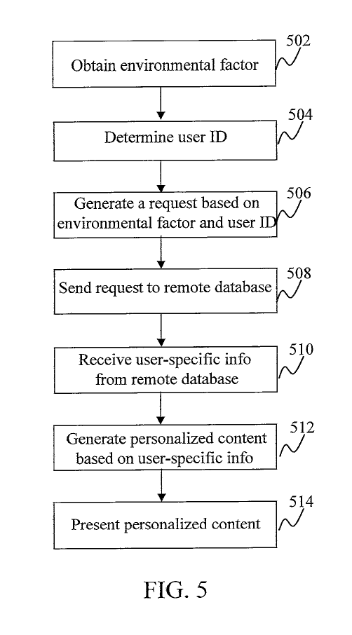

FIG. 5 is a flowchart of an exemplary process for retrieving user-specific information, according to an embodiment of the present teaching. It will be described with reference to the above figures. However, any suitable module or unit may be employed. Beginning at 502, an environment factor associated with a user is obtained. The environmental factor may be obtained from sensors or operating system of the user devices in real time and serve as a trigger for retrieving user-specific information. As described above, this may be performed by the environment factor fetching unit 208 of the application 122 and/or the environment factor unit 302 of the user-specific information retrieving module 124. At 504, a user ID associated with the user may be determined. The user ID may be unique for each user. As described above, this may be performed by the user ID unit 304 of the user-specific information retrieving module 124. It is understood that, the operations at 502 and 504 may be performed in serial as shown in FIG. 5, or in parallel.

At 506, a request may be generated based on the environment factor and the user ID. The request may include a parameter indicating the type of the user-specific information to be retrieved, such as preferences, history, and demographics. The type of the user-specific information may be determined based on a functionality of the application. The request may also include a criterion for retrieving the user-specific information, which further defines the scope the user-specific information. For example, the type of the user-specific information may be the frequency of purchasing movie tickets online assuming the functionality that currently invoked by the user in a movie application is ticket purchasing. A criterion, such as a time frame of the past six months, may also be included as another parameter to the request. As described above, this may be performed request generating unit 306 of the user-specific information retrieving module 124. The request may then be sent, at 508, to a remote database. The remote database may be located in a server, for example. At 510, user-specific information may be received from the remote database in response to the request. As described above, the 508, 510 may be performed by the information retrieving unit 308 of the user-specific information retrieving module 124. At 512, personalized content may be generated based on the user-specific information. At 514, personalized content may be presented to the user. As described above, the processes of 512 and 514 may be performed by an application 122.

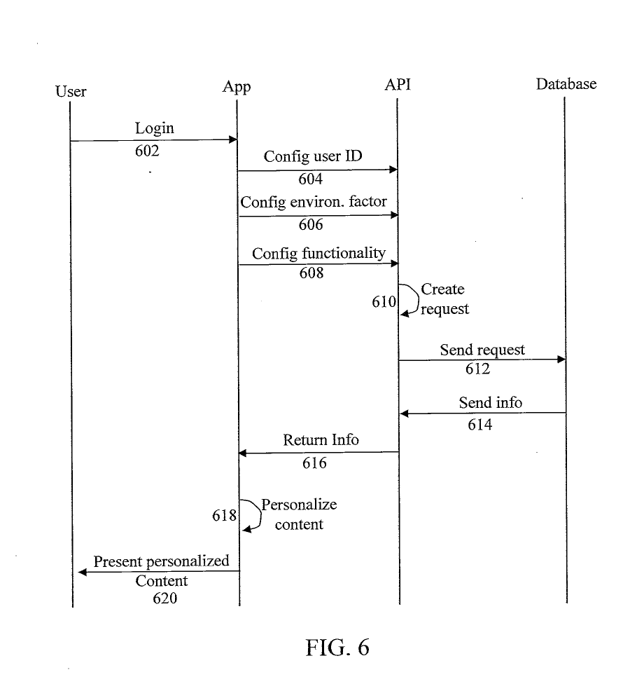

FIG. 6 is an exemplary time line chart for retrieving user-specific information, according to an embodiment of the present teaching. The time line shown in FIG. 6 represents a process performed by a user, an application, an API, and a database. In this example, the user-specific information retrieving module 124 is implemented as the API for any application running on the user device. At 602, the user may login the application for example with an user ID that is unique for the user. The application then set up of the configuration of the API by providing parameters, the user ID based at 604, a real-time environment factor obtained from some sensors at 606, and a specific functionality currently invoked by the user at 608. The processes of 604, 606, and 608 may be performed in serial or in parallel.

At 610, the API creates a request including the parameters provided by the application. The API then sends, at 612, the request to the database and receives user-specific information in response to the request from the database at 614. At 616, the API returns the user-specific information to the application. The application generates, at 618, personalized content for the user based on the user-specific information, and present, at 620, the personalized content to the user, who is currently using the application.

FIG. 7 is an exemplary functional block diagram of a user-specific information retrieving engine 310 residing on a server, according to an embodiment of the present teaching. The user-specific information retrieving engine 310 in this example may receive request related information (parameters) and obtain user-specific information from a 312 based on the request related information. The request related information may be generated at a user device based on a request associated with a user. The request related information may include a user-specific information types 704 and some criteria 702. The user-specific information types 704 may indicate a requested type of user-specific information, e.g., a preference of the user, a history of the user's behaviors, or demographics associated with the user. The criteria 702 may specify what criteria the request user-specific information should meet, e.g., the user's behaviors should be within the last three months.

Information related to users may be collected from different sources, such as user's search log, browser cookies, social media accounts, email and instant messages, etc., and consolidated in a centralized user-specific database. All the collected user information, including user profile, online activities, and user-related content, is stored for each specific user in the database, i.e., indexed by user ID. The stored data for each user is considered as raw user-specific data 706 as it has not been processed or organized yet or has only been preliminary processed, e.g., filtering out the duplicated or restricted information. In this example, a user-specific information retrieving engine 310, such as a rule-based database engine, a model/algorithm-based database engine, e.g., based on neural network or logistic regression, may further process the raw user-specific data 706 and transferred it into organized user-specific information 708 based on, for example, the user-specific information types 704 and criteria 702. For example, assuming the user-specific information types 704 may be the frequency of purchasing movie tickets online and the criteria 702 include a time frame of this year, the user-specific information retrieving engine 310 then looks at the raw users-specific data 706 for each user, for example, the browser cookies log of online movie purchasing websites generated in this year, and calculates the frequency based on the matched data. In other words, rules, such as the user-specific information types 704 and criteria 702, are used by the user-specific information retrieving engine 310 for organizing the user-specific information database 132. The frequency is then considered as part of the organized user-specific information 708. The user-specific information database 132 may store the raw user-specific data 706, the organized user-specific information 708, or both. As the organized user-specific information 708 has been generated and stored, once a request with specific parameters, such as user-specific information type, criteria, user ID, and/or environment factor, is received by the server, the matching record can be directly found and returned. In other words, the user-specific information retrieving engine 310 may pre-process some of all of the raw user-specific data 706 offline.

It is understood that, online processing may be also performed by the user-specific information retrieving engine 310 in other examples. That is, the user-specific information database 132 stores only raw user-specific data 706, and the user-specific information retrieving engine 310 processes the raw user-specific data 706 in real time based on the parameters in the received request. A hybrid mechanism combining both online and offline processing may be also possible for the user-specific information retrieving engine 310. The user-specific information retrieving engine 310 may create organized user-specific information 708 offline based on some preset rules, e.g., predetermined user-specific information types 704 and criteria 702. When a request is received, the user-specific information retrieving engine 310 determines whether the requested information has already been organized before and performs online processing only if it is not found in the existing organized user-specific information 708.

FIG. 8 is a flowchart of another exemplary process for retrieving user-specific information, according to an embodiment of the present teaching. At 802, raw user-specific data associated with a user is collected from different sources, including user's search log, browser cookies, social media accounts, email and instant messages, etc. At 804, the type of user-specific information is determined. In one example, the types of the user-specific information are predetermined for offline data processing. In another example, the types of the user-specific information are dynamically determined based on the request from the user device for online data processing. At 806, criteria for retrieving user-specific information are determined. In one example, the criteria are predetermined for offline data processing. In another example, the criteria are dynamically determined based on the request from the user device for online data processing. The organized user-specific information may be refined based on the criteria, conditions, rules or a model. At 808, the raw user-specific data is transferred into organized user-specific information in an offline manner or an online manner based on the types of the user-specific information, additional rule, e.g., criteria, or models.

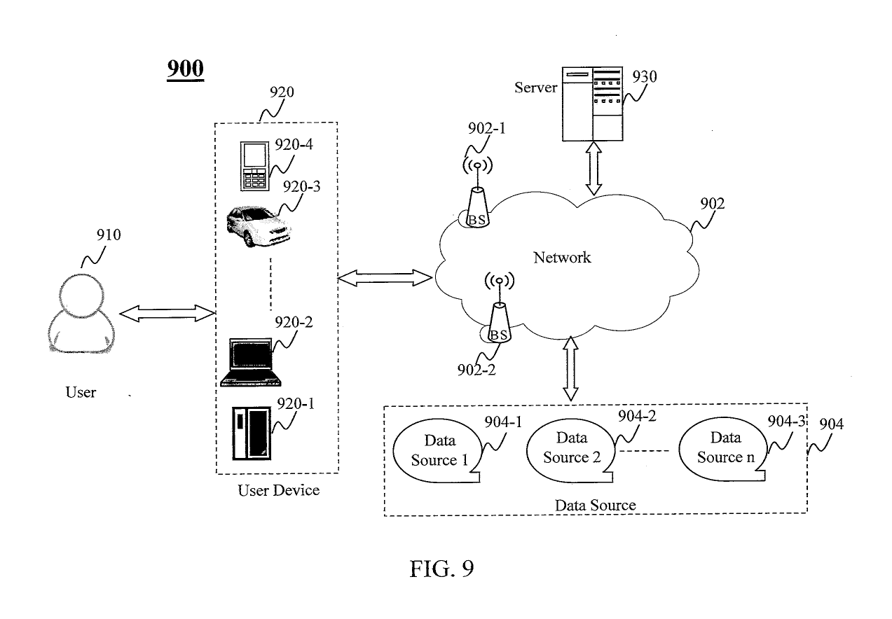

FIG. 9 is a high level depiction of a networked environment in which user-specific information retrieval is applied, according to an application embodiment of the present teaching. The networked environment 900 includes a user 910, user devices 920, a network 902, a server 930, and content sources 904. The network 902 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 902-1, . . . , 902-2, through which a data source may connect to the network in order to transmit information via the network. User devices 920 may be of different types such as desktops (920-1) connected to the network, laptop (920-2) connecting to the network via wireless connections, a handheld device (920-4), or a built-in device in a motor vehicle (920-3).

The user 110 may log in and use an application on one of the user devices 920, e.g., device 920-4. Based on log in information associated with the user 110, the user device 920-4 may send a request associated with the user 110 to the server 930, via the network 902. The server 930 may retrieve user-specific information from its user-specific information database, based on the request, and send the user-specific information to the user device 920-4. The user device 920-4 may generate personalized content based on the user-specific information and present the personalized content to the user 110, through the application.

The content sources 904 include multiple content sources 904-1, 904-2, . . . , 904-3. A content source may correspond to a web page host corresponding to an entity, whether an individual, a business, or an organization such as USPTO.gov, a content provider such as cnn.com and Yahoo.com, or a content feed source such as tweeter or blogs. The server 930 may access information from any of the content sources 904-1, 904-2, . . . , 904-3 and rely on such information to feed its user-specific information database and provide user-specific information in response to a request from one of the user devices 920.

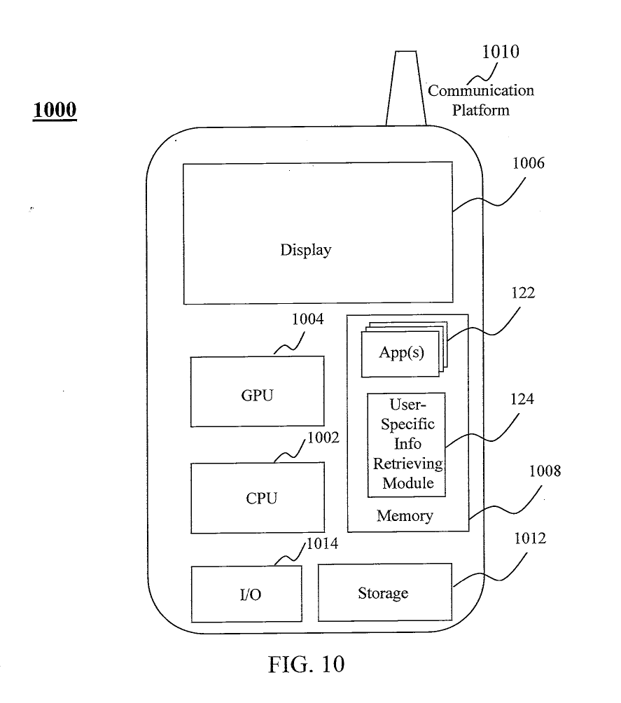

FIG. 10 is an exemplary functional block diagram of a user device on which the application and the user-specific information retrieving module shown in FIGS. 2 and 3, respectively, reside, according to an embodiment of the present teaching. In this example, the user device is a mobile device 1000, including but is not limited to, a smart phone, tablet, music player, handled gaming console, GPS. The mobile device 1000 in this example includes one or more central processing units (CPUs) 1002, one or more graphic processing units (GPUs) 1004, a display 1006, a memory 1008, a communication platform 1010, such as a wireless communication module, storage 1012, and one or more input/output (I/O) devices 1014. Any other suitable component, such as but not limited to a system bus or a controller (not shown), may also be included in the mobile device 1000. As shown in FIG. 10, one or more applications 122 and the user-specific information retrieving module 124 may be loaded into the memory 1008 from the storage 1012 in order to be executed by the CPU 1002. The user-specific information retrieving module 124 may be, for example, a software library in the form of compiled binary that is integrated in the applications 122 by third-party developers of the application 1082 on various mobile operating systems, e.g., iOS, Android, Windows Phone, etc. Execution of the applications 122 with the user-specific information retrieving module 124 may cause the mobile device 1000 to perform the processing as described above, e.g., in FIGS. 5 and 6. For example, the user interface and the personalized content may be presented to the user by the GPU 1004 in conjunction with the display 1006. The user input may be received from the user through the I/O devices 1014. The request and user-specific information may be communicated with remote databases through the communication platform 1010.

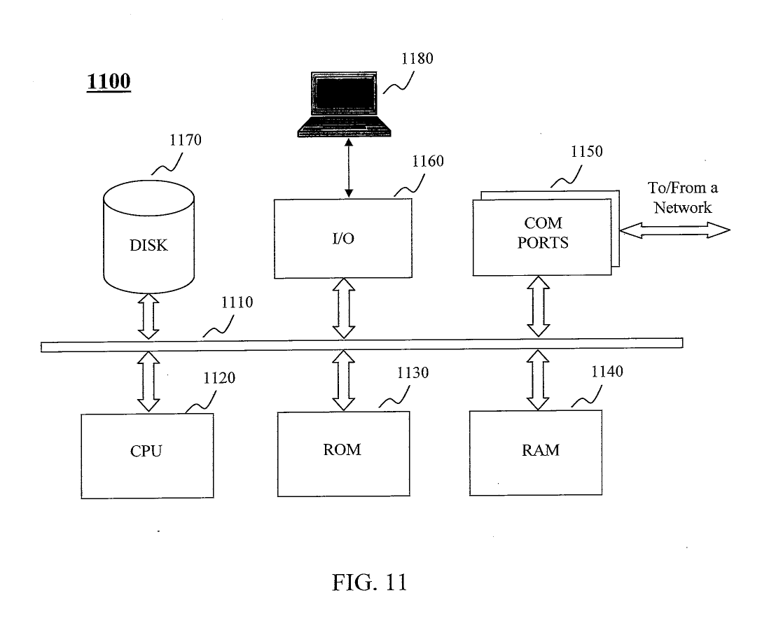

FIG. 11 depicts a general computer architecture on which the present teaching can be implemented and has a functional block diagram illustration of a computer hardware platform which includes user interface elements. The computer may be a general purpose computer or a special purpose computer. This computer 1100 can be used to implement any components of the user-specific information retrieval architecture as described herein. Different components of the systems, as depicted in FIGS. 1-3, can all be implemented on a computer such as computer 1100, via its hardware, software program, firmware, or a combination thereof. Although only one such computer is shown, for convenience, the computer functions relating to user-specific information retrieval may be implemented in a distributed fashion on a number of similar platforms, to distribute the processing load.

The computer 1100, for example, includes COM ports 1150 connected to and from a network connected thereto to facilitate data communications. The computer 1100 also includes a central processing unit (CPU) 1120, in the form of one or more processors, for executing program instructions. The exemplary computer platform includes an internal communication bus 1110, program storage and data storage of different forms, e.g., disk 1170, read only memory (ROM) 1130, or random access memory (RAM) 1140, for various data files to be processed and/or communicated by the computer, as well as possibly program instructions to be executed by the CPU. The computer 1100 also includes an I/O component 1160, supporting input/output flows between the computer and other components therein such as user interface elements 1180. The computer 1100 may also receive programming and data via network communications.

Hence, aspects of the methods of retrieving user-specific information, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the search engine operator or other explanation generation service provider into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine each of which has at least one processor, storage, and a communication platform connected to a network for retrieving user-specific information, the method comprising the steps of:
obtaining an environment factor associated with a user;
determining an identification of the user;
sending a request for retrieving user-specific information to a remote database, wherein the request is generated based on the environment factor and the identification of the user; and
receiving the user-specific information sent from the remote database in response to the request.

2. The method of claim 1, wherein the environment factor is obtained from a mobile device of the user.

3. The method of claim 2, wherein the environment factor includes at least one of location, time, weather, motion state, direction, wireless signal strength, ambient-light intensity, and power state.

4. The method of claim 1, wherein the request includes a parameter indicating a type of the user-specific information.

5. The method of claim 4, wherein the type of the user-specific information includes at least one of preferences, history, and demographics.

6. The method of claim 4, wherein the parameter is determined based on a functionality of an application implemented on a mobile device of the user.

7. The method of claim 4, wherein the parameter includes at least one criterion for retrieving the user-specific information.

8. The method of claim 1, further comprising:
generating personalized content for the user based on the retrieved user-specific information; and
presenting the personalized content to the user.

9. The method of claim 1, wherein the remote database is a centralized database collecting the user-specific information from a plurality of data sources.

10. A system for retrieving user-specific information comprising a user-specific information retrieving module implemented on a mobile device, the user-specific information retrieving module comprises:
an environment factor unit configured to obtain an environment factor associated with the mobile device of a user;
a user identification unit configured to determine an identification of the user; and
an information retrieving unit configured to:
send a request for retrieving user-specific information to a remote database, wherein the request is generated based on the environment factor and the identification of the user, and
receive the user-specific information sent from the remote database in response to the request.

11. The system of claim 10, wherein the environment factor includes at least one of location, time, motion state, direction, wireless signal strength, ambient-light intensity, and power state.

12. The system of claim 10, wherein the request includes a parameter indicating a type of the user-specific information.

13. The system of claim 12, wherein the type of the user-specific information includes at least one of preferences, history, and demographics.

14. The system of claim 12, wherein the parameter is determined based on a functionality of an application implemented on the mobile device of the user.

15. The system of claim 12, wherein the parameter includes at least one criterion for retrieving the user-specific information.

16. The system of claim 10, further comprising an application implemented on the mobile device configured to:
generate personalized content for the user based on the retrieved user-specific information; and
present the personalized content to the user.

17. The system of claim 10, wherein the remote database is a centralized database collecting the user-specific information from a plurality of data sources.

18. A machine-readable tangible and non-transitory medium having information recorded thereon for retrieving user-specific information, wherein the information, when read by the machine, causes the machine to perform the following:
obtaining an environment factor associated with a user;
determining an identification of the user;
sending a request for retrieving user-specific information to a remote database, wherein the request is generated based on the environment factor and the identification of the user; and
receiving the user-specific information sent from the remote database in response to the request.

19. The medium of claim 18, wherein the environment factor is obtained from a mobile device of the user.

20. The medium of claim 18, further comprising:
generating personalized content for the user based on the retrieved user-specific information; and
presenting the personalized content to the user.
